(19) United States
(12) Patent Application Publication
(10) Pub. No.: US 2005/0149381 A1
(43) Pub. Date: Jul. 7, 2005

(54) Method and system for estimating price elasticity of product demand

(75) Inventors: Kiran Kumar Ravulapati, Evanston, IL (US); Katia Cristina Frank, Alpharetta, GA (US); Ramanujan Thirumalai, Evanston, IL (US)

Correspondence Address: James M. Hannon, Esq.;KING & SPALDING LLP, 45th Floor, 191 Peachtree Street, Atlanta, GA, 30303-1763, US

(73) Assignee: Delta Air Lines, Inc., Atlanta, GA (US)

(21) Appl. No.: 11/009,945

(22) Filed: Dec. 10, 2004

Related U.S. Application Data
(60) Provisional application No. 60/529,456, filed on Dec. 12, 2003.

(51) Int. Cl. G06F 17/60

(52) U.S. Cl. 705/10

(57) ABSTRACT

Estimating price elasticity of product demand assists an understanding of total demand for a product and a forecast of how the level of demand for that product will change based on a change in the price of the product. A multi-level hierarchical regression methodology can be used to forecast product demand, and thereby calculate price elasticity. The methodology accepts historical product sales, product prices, and revenue management controls of a company and predicts the estimated demand at the product level. This methodology can also accept the historical product sales, product prices for the company and its competitors, revenue management controls of a company, and an estimate of the revenue management controls of its competitors to predict the estimated demand at the product level.

### STATEMENT OF RELATED PATENT APPLICATION

This non-provisional patent application claims priority under 35 U.S.C. § 119 to U.S. Provisional Patent Application No. 60/529,456, titled Estimating Price Elasticity of Airline Product Demand, filed Dec. 12, 2003. This provisional application is hereby fully incorporated herein by reference.

### FIELD OF THE INVENTION

The present invention relates to the field of demand forecasting. In particular, the present invention relates to forecasting demand and calculating price elasticity in industries where product inventory is controlled using a revenue management system.

### BACKGROUND OF THE INVENTION

Sales organizations, such as airlines, publish prices for thousands of products. To determine the “right” price for each product, it is important to know the price elasticity which measures the impact of price on demand. To compute price elasticity, mathematical models are needed that link demand and price. Currently there are no methods available to forecast demand for a company's products when the company uses a revenue management system to control inventory for its products. A revenue management system typically assists a company in deciding how much inventory should be sold for each product and at what price that product should be sold. Hence, the observed sales of the product, also called a constrained demand for the product, does not represent the absolute demand for the product. This is analogous to a stock-out situation in a retail store except that these stock-outs occur frequently in particular industries, such as the transportation and hotel industries. It is a common practice to fix this problem by unconstraining (a way of increasing) the observed sales. This may not be effective in the context of industries like transportation and hotels where stock-outs occur frequently for many products, because the revenue management systems used by companies in those industries are typically set up to offer only a limited supply of each product.

Most of the research on price elasticity in air transportation and related industries has focused on predicting demand at an aggregate level, where revenue management effects can be ignored. Price elasticity from the aggregate level will not be useful for making pricing decisions on a daily basis, as the revenue management effects cannot be ignored at the product level. For example, total demand for a representative origin-destination pair, where San Francisco is the origin and Boston is the destination, is little affected by the revenue management systems of airlines because, in most instances, at least one product for the origin-destination pair is available at a certain point in time. However, the demand for a product having the above origin and destination and that must be purchased at least fourteen days before the departure date is strongly affected by the revenue management system because the revenue management system restricts demand to a level that is less than total demand for the product. Hence, price elasticity at an origin-destination pair level cannot be used to predict demand at the product level.

In view of the above reasons, companies that control inventories using revenue management systems either do not make any forecasts at the product level or resort to ad hoc techniques which are not accurate. Such ad hoc techniques include a review of historical sales data to estimate demand for a product. However, since revenue management systems restricted full demand for the product in the past, using historical sales data is inaccurate for estimating total demand for a product in the future. Therefore, pricing managers at companies where inventory is controlled by a revenue management system tend to rely on experience and gut feeling to make decisions related to how changing the price of a product would affect its total demand. Effective methodologies to accurately forecast product demand that are managed by a revenue management system have yet to be invented.

In view of the foregoing there is a need in the art for effective methodologies to accurately forecast total demand for a product whose inventory is controlled by a revenue management system. There is further need in the art for the ability to forecast total demand for a product at the booking day level based on potential changes in price to one or more products available on that booking day.

### SUMMARY OF THE INVENTION

A product demand and price elasticity estimating software system supports an analysis of how a price change in one product of an origin-destination pair affects the absolute demand for that product, and all other products, for that particular origin-destination pair. The product demand and price elasticity estimating system can also support a determination and analysis of how a price change or a change in the revenue management effect for a competing product can affect the demand for all products for the origin-destination pair.

A product can differ from an origin-destination pair in the following way, using an airline industry example. Assume a passenger requests travel service from Atlanta (ATL) to Los Angeles (LAX). Depending on the availability, an airline might offer various products to satisfy the request, such as the following: (1) product BA3, which can be bought up to three days before departure and does not require a Saturday night stay; and (2) product UA14TN, which can only be bought at least 14 days prior to departure and requires the passenger to stay at the destination, in this case Los Angeles, over a Saturday night before returning to the origin, Atlanta. Products might also include, for example, the class of service (business class, first class, coach, etc.), and the days the product is available.

In order to estimate individual product demand at the booking-day level, the system typically solves a multinomial logistical regression that accepts as inputs the proposed price of the product, the revenue management effect for the product, and the historical demand share for the product. The system estimates demand at the booking-day level, which is distinct from most revenue management systems that estimate demand at the departure-day level. Industries employing a revenue management system to control inventory typically publish prices that are applicable for all products in the future. Since a product's price may impact demand across more than one departure date, it is beneficial to forecast demand at a booking-day level rather than a departure-day level.

A revenue management system typically decides the amount of product that may be sold using a set of rules and restrictions that generally prevent the entire inventory of an origin-destination pair from being available at a single point in time. The revenue management effect typically represents the set of rules restricting the amount of available inventory for a particular origin-destination pair.

In another aspect, the system can estimate the individual product demand at the booking-day level by accepting as inputs the proposed price of the product, the revenue management effect for the product, the historical demand share for the product, the current price for a competitor's product and the revenue management effect for a competitor's product. In order for the system to estimate the individual product demand while accepting the price and revenue management effect for a competitor's product as inputs, the competitor's product should be substantially equivalent to the product for which demand is being estimated.

The present invention further supports a system capable of estimating the demand for categories within an origin-destination pair. Categories typically include one or more products that have similar attributes. As with individual products, there is no limit to the number of categories that can be included in an origin-destination pair. In one example, products can be split up into categories based on the number of days the current booking day is away from the departure date of the product. In order to estimate the category demand at the booking-day level, the system typically solves a generalized logistical regression that accepts as inputs a proposed weighted average price for each category of the origin-destination pair, the long-term demand share history, and the short-term demand share history for each category.

The proposed weighted average price typically represents the sum of the multiplication of a proposed price for a product by its demand share and the multiplication of all other products in the category by their respective demand shares. The proposed price is different from the actual price if a new price is being evaluated for a particular product in the category. By way of a representative example, the short-term demand share history can represent the demand for the category of products over the previous one or two day period. The long-term demand share history can represent the demand for the category of products over the prior seven day period of time.

The present invention can further support a system capable of estimating the absolute demand for an origin-destination pair. In order to estimate the absolute demand for the origin-destination pair at the booking day level, the system can solve a regression equation that accepts as inputs a proposed average price for the origin-destination pair, the long-term demand share history, and the short-term demand share history at the origin-destination pair level. As with the example of the long and short-term demand share histories at the category level, the short-term demand share history can represent the demand for the origin-destination pair over the previous one or two day period, while the long-term demand share history can represent the demand for the origin-destination pair over the prior seven day period of time.

### BRIEF DESCRIPTION OF THE DRAWINGS

For a more complete understanding of exemplary embodiments of the present invention and the advantages thereof, reference is now made to the following description in conjunction with the accompanying drawings in which:

FIG. 1 is a block diagram illustrating an exemplary operating environment for implementation of various embodiments of the present invention;

FIG. 2 is a block diagram illustrating a multi-level hierarchy of products available;

FIG. 3 is a flow chart illustrating the steps of a process for determining a product demand forecast in accordance with an exemplary embodiment of the present invention;

FIG. 4 is a flow chart illustrating the steps of a process for determining the demand share of products in a category C, in accordance with an exemplary embodiment of the present invention;

FIG. 5 is a flow chart illustrating the steps of a process for determining the demand share for all categories C of an origin-destination pair, in accordance with an exemplary embodiment of the present invention;

FIG. 6 is a flow chart illustrating the steps of a process for determining the weighted average price (a′ or a) of category (C), in accordance with an exemplary embodiment of the present invention;

FIG. 7 is a flow chart illustrating the steps of a process for determining the absolute demand (D) for an origin-destination pair, in accordance with an exemplary embodiment of the present invention; and

FIG. 8 is a flow chart illustrating the steps of a process for determining the weighted average price (k′ or k) for an origin-destination pair, in accordance with an exemplary embodiment of the present invention.

### DETAILED DESCRIPTION OF THE EXEMPLARY EMBODIMENTS

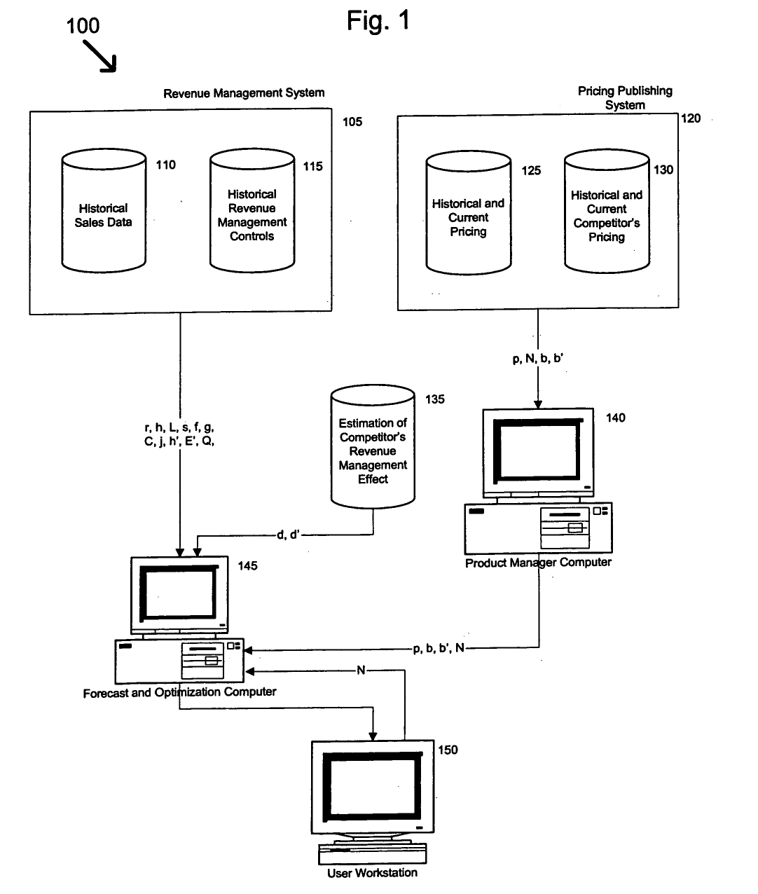

The present invention supports a determination of the estimation of the price elasticity for one or more products in an origin-destination pair, as can be more readily understood by reference to system 100 in FIG. 1. FIG. 1 is a block diagram illustrating an exemplary price elasticity system 100 constructed in accordance with an exemplary embodiment of the present invention. The exemplary price elasticity system 100 comprises a revenue management system 105, a pricing publishing system 120, an estimation of a competitor's revenue management effect 135, a product manager computer 140, a forecast and optimization computer 145, and a workstation 150.

The revenue management system 105 is communicably attached via a computer network to the forecast and optimization computer 145. The revenue management system 105 typically contains historical sales data 110 and historical revenue management controls 115. The revenue management system 105 can transmit information to the forecast and optimization computer 145 including, but not limited to, the revenue management effect, the historical demand of an origin-destination product, the long-term demand share history for a category of products for an origin-destination pair, the short-term demand share history for a category of products for an origin-destination pair, the long-term demand share history for an origin-destination pair, the short-term demand share history for an origin-destination pair, a category of products for an origin-destination pair, and one or more products available for an origin-destination pair.

The historical sales data 110 typically represents a database containing data of past performance for products in each origin-destination pair. The historical sales data 110 can include the historical demand of an origin-destination product, the long-term demand share history for a category of products for an origin-destination pair, the short-term demand share history for a category of products for an origin-destination pair, the long-term demand share history for an origin-destination pair, the short-term demand share history for an origin-destination pair, a category of products for an origin-destination pair, one or more products available for an origin-destination pair, and the sale price for products in an origin-destination pair.

The historical revenue management controls 115 typically represents a database that contains one or more rules imposed on sales of products in an origin-destination pair. An example of a revenue management control may include a rule that a particular price for a product in an origin-destination pair is only available if the product is not used on Saturday, Sunday, or during specific holiday periods.

The pricing publishing system 120 is communicably attached via a computer network to the product manager computer 140. The pricing publishing system 120 typically contains internal historical and current pricing 125 for products and categories in an origin-destination pair. The pricing publishing system 120 can also contain historical and current competitor's pricing 130 via the Internet or an external service. The pricing publishing system 120 can transmit information to the product manager computer 140 including, but not limited to, the price (p) for products in an origin-destination pair and the competitor's price (b′ or b) for competitor's products. The historical and current pricing 125 typically represents a database containing previous internal prices for products in an origin-destination pair. The historical and current competitor's pricing 130 typically represents a database containing a list of competitor's products, historical pricing data for competitor's products, and current prices for competitor's products. The price of competitor's products, both current and historical, can be obtained through publicly accessible, well known websites via the Internet.

The estimation of competitor's revenue management effect 135 is communicably attached via a computer network to the forecast and optimization computer 145. The estimation of competitor's revenue management effect 135 typically represents a database containing publicly available information necessary for estimating a competitor's revenue management controls. Such information may include the type of revenue management system used by a competitor, the current set of rules being imposed by a competitor for a particular competitor product, and whether that product is being offered by the competitor or not. With the publicly available information, the estimation of competitor's revenue management effect 135 can estimate the competitor's revenue management effect for a substantially equivalent competitor product in an origin-destination pair. The estimation of competitor's revenue management effect 135 can transmit to the forecast and optimization computer 145 information including, but not limited to, an estimated revenue management effect for a substantially equivalent competitor product for the origin-destination pair. In one exemplary embodiment, the system 100 is capable of estimating the price elasticity for one or more products in an origin-destination pair without the use of the historical and current competitor's pricing 130, the estimation of competitor's revenue management effect 135, and the product manager computer 140.

The product manager computer 140 is communicably attached via a computer network to the pricing publishing system 120 and the forecast and optimization computer 145. The product manager computer typically contains a database of internal products available for each origin-destination pair and a list of competitor's products that are available for the competitor's origin-destination pairs. The product manager computer is typically capable of determining which, if any, competitor's products for a competitor's origin-destination pair is substantially equivalent to one or more internal products for an internal origin-destination pair. The product manager computer 140 can then generate an equivalency map comparing internal and competitor products. In one exemplary embodiment, the product manager computer 140 generates separate equivalency maps for domestic and international products. An international product is one in which either the origin or the destination for the origin-destination pair is not located in the United States of America (USA). A domestic product is one in which both the origin and the destination for the origin-destination pair is located in the USA. The product manager computer 140 can transmit information to the forecast and optimization computer 145 including, but not limited to, the price (p or N) for internal products and the competitor's price (b′ or b) for products that are substantially equivalent to the internal products.

The forecast and optimization computer 145 is communicably attached via a computer network to the revenue management system 105, the estimation of competitor's revenue management effect 135, the product manager computer 140, and the workstation 150. The forecast and optimization computer 145 is capable of receiving inputs from the workstation 150 including, but not limited to, a new price (N) for a product in the origin-destination pair. The forecast and optimization computer 145 can transmit to the workstation 150 information including, but not limited to, the demand for each product in an origin-destination pair. The forecast and optimization computer 145 typically contains one or more programs capable of solving one or more logistical regression equations in order to determine the demand for each product in an origin-destination pair based on a change in price for a product in the origin-destination pair. In one exemplary embodiment, the forecast and optimization computer 145 is capable of solving simple regression equations multinomial logistical regression equations and nested logistical regression equations.

The workstation 150 is communicably attached via a computer network to the forecast and optimization computer 145. The workstation 150 allows a user to enter commands and information into the forecast and optimization computer 145 by using input devices, such as a keyboard or mouse. In one exemplary embodiment, a user inputs one or more proposed new prices (N) for one or more products in an origin-destination pair at the workstation 150 in order to determine how the change in price for a product will affect the demand for each product and the overall demand for the origin-destination pair. The workstation 150 typically includes a monitor capable of displaying the results of the demand at different levels (product, category, absolute) for the origin-destination pair that can be transmitted by the forecast and optimization computer 145.

Although other elements of the operating environment 100 are not shown, those of ordinary skill in the art will appreciate that such components and the interconnection between them are known. Accordingly, additional details concerning the elements of the operating environment 100 need not be disclosed in connection with the present invention for it to be implemented by those of ordinary skill in the art.

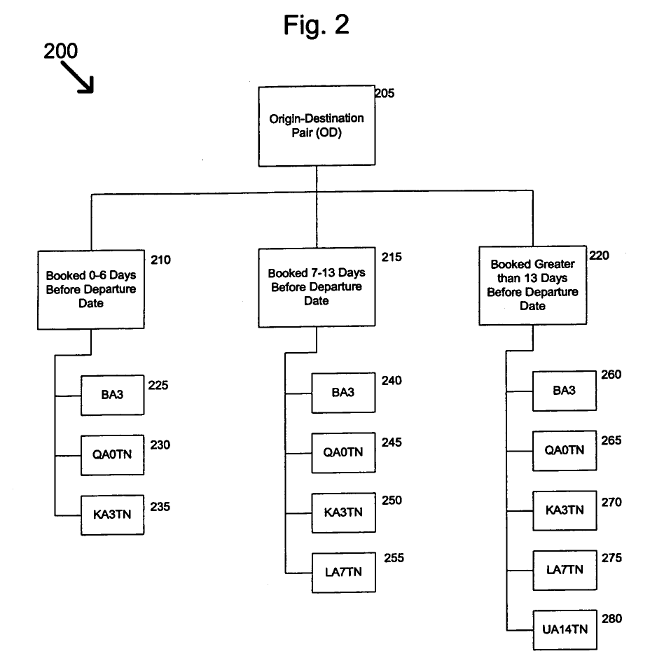

FIG. 2 is a block diagram representing an exemplary multi-level hierarchy 200 of products. The exemplary hierarchy 200 represents a multi-level listing of products available for an origin-destination pair 205 in the airline industry, however, this hierarchal procedure is generic and can be extended to products in other industries that use revenue management systems to manage available inventory. The origin-destination pair 205 can be further broken down into one or more categories represented in 210-220, which in turn can be further broken down into products available in each category 225-280. The description of the distinction between an origin-destination pair 205 and products in the origin-destination pair 205 can best be understood from a representative example from the air transportation field. A passenger requests travel service from Atlanta (ATL) to Los Angeles (LAX). Depending on the availability, an airline might offer various products to satisfy the request: (1) product BA3, which can be bought up to three days before departure and does not require a Saturday night stay; and (2) product UA14TN, which can only be bought at least 14 days prior to departure and requires the passenger to stay at the destination, in this case Los Angeles, over a Saturday night before returning to the origin, Atlanta.

In the exemplary hierarchy 200 the categories 210-220 represent the number of days before the departure date that a ticket is booked by a consumer. The departure date is the day the consumer uses the first segment of the origin-destination pair 205. A consumer who books a flight six days or less before the departure date would be offered products in category 210. In this exemplary diagram, products 225-235 are available for category 210. A consumer who books a flight comprising the origin-destination pair 215 between seven and thirteen days before the departure date would be offered products available in category 215, which contains representative products 240-255. Finally, a consumer who books a flight more than thirteen days before the departure date would select from products available in category 220, which contains the representative products 260-280. Each product can be in more than one category at a time. It is well understood by those of ordinary skill in the art that the number of categories and how products are separated into categories is completely adjustable to fit the industry and product orientation.

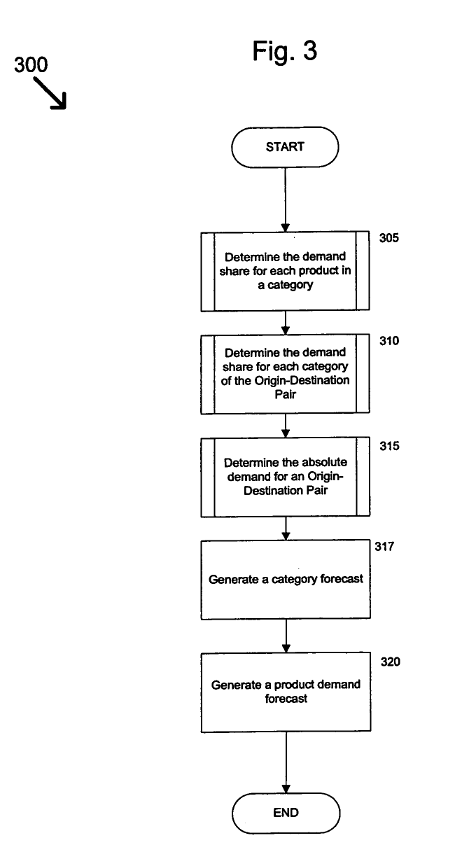

FIGS. 3-8 are logical flowchart diagrams illustrating the computer-implemented processes completed by an exemplary embodiment of the price elasticity system 100. Turning now to FIG. 3, a logical flow chart diagram 300 is presented to illustrate the general steps of an exemplary process for estimating price elasticity of an origin-destination pair in accordance with the price elasticity system 100 of FIG. 1.

Now referring to FIGS. 1, 2, and 3, the exemplary method 300 begins at the START step and proceeds to step 305, in which the forecast and optimization computer 145 determines the demand share for each product in a category 210-220. As shown in exemplary FIG. 2, the category 0-6 days includes products 225-235, the category 7-13 days 215 includes products 240-255, and the category greater than 13 days 220 includes products 260-280. In one exemplary embodiment, the demand share for each product in a category is determined by solving a multinomial linear regression model of McFadden. In another exemplary embodiment, the demand share for each product category is determined by solving a nested logistical regression equation.

In step 310, the forecast and optimization computer 145 determines the demand share for each category 210-220 of the origin-destination pair 205. In one exemplary embodiment, a generalized logistic regression model is used to determine the demand share for each category 210-220. The forecast and optimization computer 145 determines the absolute demand for an origin-destination pair 205 in step 315. In one exemplary embodiment, the absolute demand is determined using a simple regression model. The forecast and optimization computer 145 generates a category forecast in step 317. In one exemplary embodiment, the category forecast is the product of the results obtained in steps 310 and 315. In step 320, the forecast and optimization computer 145 generates a demand forecast for each product in the origin-destination pair 205. The process 300 continues to the END step.

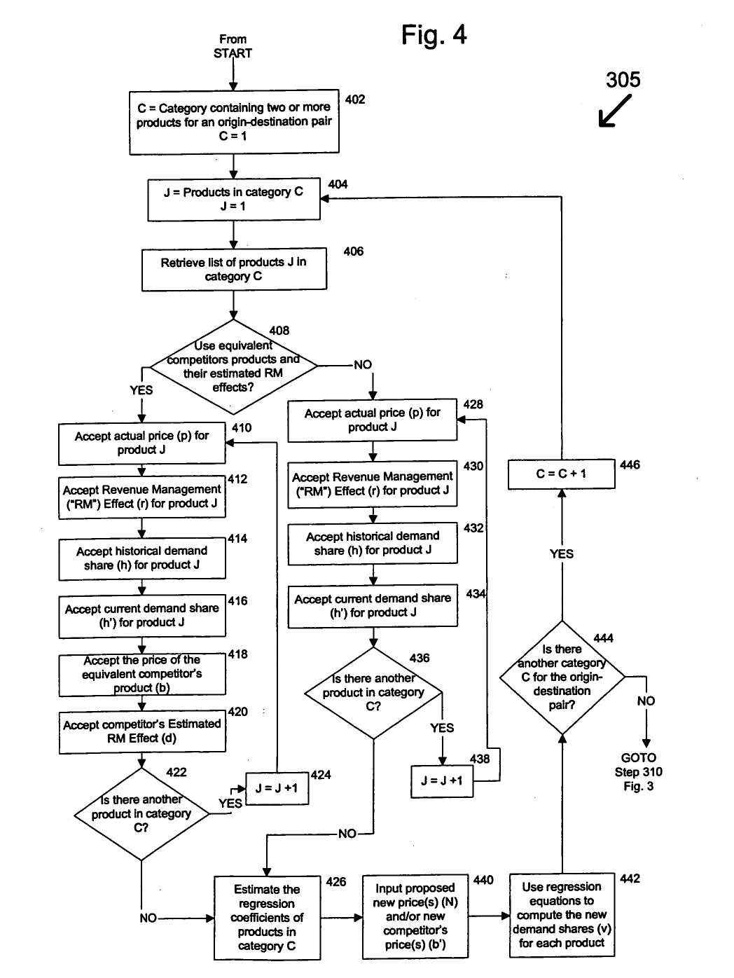

FIG. 4 is a logical flow chart diagram illustrating an exemplary computer-implemented method for determining the demand share for products in a category, as completed by step 305 of FIG. 3. Referencing FIGS. 1, 2, and 4, the exemplary method 305 begins at step 402, where a counter variable, C, is set equal to one. The counter variable C typically represents a category 210-220 than can contain one or more products for an origin-destination pair 205. In the situation where a category contains only one product, step 305 is not necessary, because the demand share for lone product in the category will be 100 percent. In step 404, the counter variable, J, is set equal to one. The counter variable J typically represents the products available for an origin-destination pair 205 in category C.

In step 406, the forecast and optimization computer 145 accepts the list of products J in category C from the revenue management system 105. In step 408, an inquiry is conducted to determine if the regression equation to be solved will include the prices for substantially equivalent competitor's products (b′ or b) and the competitor's estimated revenue management effect (d). In one exemplary embodiment, the demand share (v) for products J in a category C is determined using a multinomial logistical regression model that includes in the regression formula prices for substantially equivalent competitor's products (b) and the competitor's estimated revenue management effect (d′ or d). In another exemplary embodiment, the demand share (v) for products J in category C is determined using a multinomial logistical regression equation that does not include in the equation prices for substantially equivalent competitor's products (b′ or b) and the competitor's estimated revenue management effect (d′ or d).

In one exemplary embodiment the use of a competitor's price for substantially equivalent products cannot be used in the regression equation unless an estimate of the competitor's revenue management effect is also used in the equation. Furthermore, in one exemplary embodiment, competitor information can only be used if it is used for all products in a category C. The decision whether or not to include, in the regression equation, the prices for substantially equivalent competitor's products (b′ or b) and the competitor's estimated revenue management effect (d′ or d) can be based on several factors including, but not limited to, the availability of the information, the importance of competitor pricing to demand, and the historical review of the effectiveness of the model with or without these variables. The competitor's prices and estimated revenue management effect can typically be determined by obtaining publicly available information in publicly accessible databases and via the Internet. The estimate of the competitor's revenue management effect (d) can be affected by the type of revenue management system used by the competitor and the sales restrictions put in place by the competitor for its substantially equivalent products on the booking day.

If the price of the substantially equivalent competitor product and the competitor's estimated revenue management effect will be used, the “YES” branch is followed to step 410, where the forecast and optimization computer 145 accepts the actual price (p) for product J from the historical and current pricing database 125. In step 412, the revenue management effect (r) for product J is accepted by the forecast and optimization computer 145 from the historical revenue management controls 115. The forecast and optimization computer 145 accepts the historical demand share (h) for product J from the historical sales data 110 in step 414. In step 416, the forecast and optimization computer 145 accepts the current demand share (h′) for product J from historical sales data 110.

The forecast and optimization computer 145 accepts the price of the substantially equivalent competitor product (b) from the historical and current competitor's pricing database 130 in step 418. The price of a competitor's products can generally be determined from publicly available information in publicly accessible databases and on the Internet. In step 420, the competitor's estimated revenue management effect (d) is accepted by the forecast and optimization computer 145 from the estimation of competitor's revenue management effect 135. The information needed to estimate competitors' revenue management effects can generally be determined from publicly available information in publicly accessible databases and on the Internet.

In step 422, an inquiry is conducted to determine if category C contains another product J. If so, the “YES” branch is followed to step 424, where the variable J is incremented by one. The process subsequently returns to step 410. However, if category C does not contain another product J then the “NO” branch is followed to step 426, where an estimation is made of the regression coefficients in the regression equation for products J in category C. In one exemplary embodiment, the regression coefficients are estimated using equations (1) or (2):
h′ⱼ=αⱼ+βⱼpⱼ+γⱼrⱼ+ηⱼhⱼ for JεC or (1)
h′ⱼ=αⱼ+βⱼpⱼ+γⱼrⱼ+ηⱼhⱼ+λⱼbⱼ+ωⱼdⱼ for jεC (2)
depending on whether or not competitor's price and revenue management effect is input to determine the product demand share (h′).

To arrive at the equations above, the following equations were derived. The demand share for a product is computed by deriving utilities (attractiveness) for all products in the category. In this model, a customer's choice among products in a category (C_{α}) will correspond to the product with the highest utility. For each product j in the category (C_{α}), let (uᵢⱼ) be the utility for customer(i) and product (j). Then,
uᵢⱼ=h′ᵢⱼ+εᵢⱼ∀jεC_{α},
where (h′ⱼ) is a non-stochastic utility for product (j) that reflects the ‘representative’ preferences of customer (i), and εᵢⱼ is a random component that corresponds to the idiosyncrasies of customer (i) for product (j). Notice that we call h′ⱼ “product demand share” and “utility” indistinctively, since product demand shares can be obtained by normalizing the utilities. The probability of customer (i) choosing product (j) from category (C_{α}) is given by the following equation:

$$\begin{matrix}P ( j / {C}_{α} ) = P ( {u}_{ij} > max ( {u}_{ik} ) ) \\ = P ( {h}_{ij}^{′} + {ɛ}_{ij} > max ( {h}_{ik}^{′} + {ɛ}_{ik} ) ) ∀ ( k \neq k ) ∈ {C}_{α} .\end{matrix}$$

Assuming that εᵢⱼ follows an extreme value type I distribution, the conditional probabilities P(j/C_{α}) can be found using the multinomial logistical formulation of McFadden (1974) as follows:

$$P ( j / {C}_{α} ) = {ⅇ}^{{h}_{ij}^{′}} / {\sum }_{∀ k ∈ {C}_{α}}^{} {ⅇ}^{{h}_{ik}^{′}} .$$

The formulation implies that the property of independence from irrelevant alternatives be satisfied. All cross effects are assumed to be equal, so that if a product (j) gains in utility, it draws share from all other products in proportion to their current shares. If the independence from irrelevant alternatives does not hold, alternative models such as a nested logit regression model can be used.

Returning to the inquiry in step 408, if the price of the substantially equivalent competitor product (b) and the competitor's estimated revenue management effect (d) will not be used in the regression equation, the “NO” branch is followed to step 428. In step 428 the forecast and optimization computer 145 accepts the actual price (p) for product J from the historical and current pricing database 125. In step 430, the revenue management effect (r) for product J is accepted by the forecast and optimization computer 145 from the historical revenue management controls 115. The forecast and optimization computer 145 accepts the historical demand share (h) for product J from the historical sales data 110 in step 432. In step 434, the forecast and optimization computer 145 accepts the current demand share (h′) for product J from historical sales data 110.

In step 436, an inquiry is conducted to determine if category C contains another product J. If so, the “YES” branch is followed to step 438, where the variable J is incremented by one. The process subsequently returns to step 428. However, if category C does not contain another product J, then the “NO” branch is followed to step 426, where an estimation is made of the regression coefficients in the regression model for products J in category C, as shown above. In step 440, the forecast and optimization computer 145 can receive proposed prices (N) for product J from the workstation 150 and can receive new competitor prices (b′) for substantially equivalent competitor products from the historical and current competitor's pricing 130.

The forecast and optimization computer 145 computes the new demand share (v) for product J using regression equations in step 442. In one exemplary embodiment, the regression equation used by the forecast and optimization computer 145 is a multinomial logistical regression formulation of McFadden. In another exemplary embodiment the regression equation used by the forecast and optimization computer 145 is a nested logistical regression equation. The multinomial logistical regression utility equations typically take one of the two following equation forms (3) or (4):
vⱼ=αⱼ+βⱼNⱼ+γⱼrⱼ+ηⱼhⱼ+λⱼbⱼ+ωⱼdⱼ or (3)
vⱼ=αⱼ+βⱼNⱼ+γⱼrⱼ+ηⱼhⱼ (4)
wherein α, β, γ, η, λ, and ω represent coefficients in the regression equation. The equations are solved for all products J in category C. The selection between the two regression equations is based on whether the competitor's price for a substantially equivalent product and the competitor's estimated revenue management effect are used.

In step 444, an inquiry is conducted to determine if category C contains another product J for the origin-destination pair 205. If so, the “YES” branch is followed to step 446, where the counter variable C is increased by one. The process subsequently returns to step 404 for the selection of the next product J from category C. If, on the other hand, category C does not contain another product J, the “NO” branch is followed to step 310 of FIG. 3.

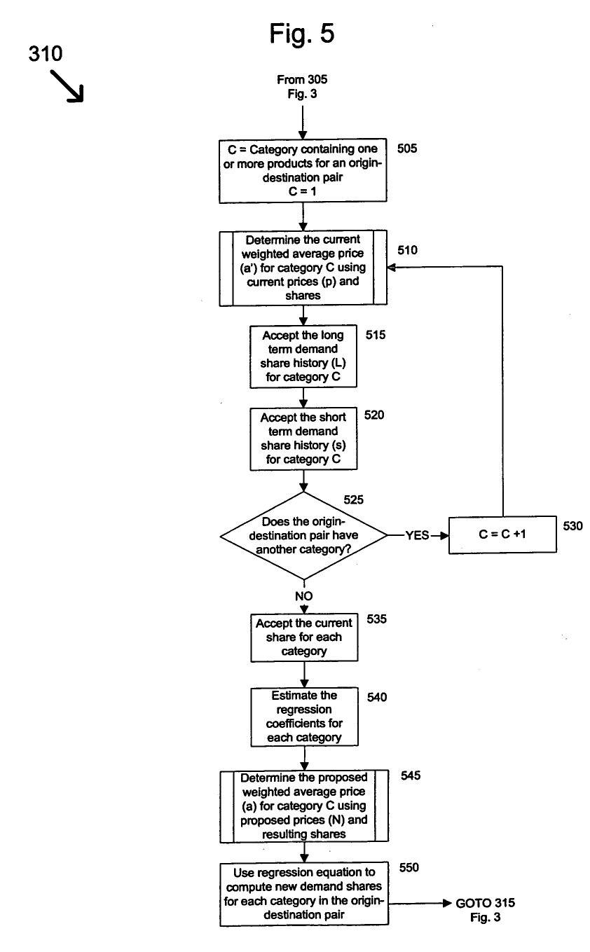

FIG. 5 is a logical flowchart diagram illustrating an exemplary computer-implemented process for determining the demand share for all categories C of an origin-destination pair, in accordance with an exemplary embodiment of the present invention as completed by step 310 of FIG. 3. Referencing FIGS. 1, 2, and 5, the exemplary method 310 begins at step 505, where a counter variable, C, is set equal to one. The counter variable C typically represents a category 210-220 that can contain one or more products for an origin-destination pair 205.

In step 510, the forecast and optimization computer 145 determines the current weighted average price (a′) for category C using current prices (p) and current demand share (h′) for each product in category C. The current price (p) is typically accepted from the pricing publishing system 120. The historical share for products in category C is typically accepted from the revenue management system 105.

The forecast and optimization computer 145 accepts the long-term demand share history (L) and the short-term demand share history (s) for the entire category C in steps 515 and 520 respectively. The long-term (L) and short-term (s) demand share data can be accepted from the revenue management system 105. In one exemplary embodiment long-term demand is the demand for a category or products over the previous seven (7) days and short-term demand is the demand for a category of products in the previous booking day.

In step 525, an inquiry is conducted to determine if historical revenue management controls database 115 contains another category C. If so, the “YES” branch is followed to step 530, where the forecast and optimization computer 145 increases the counter variable by one and returns to step 510. However, if no other categories exist in the historical revenue management controls database 115, the “NO” branch is followed to step 535. In step 535, the forecast and optimization computer 145 accepts the current share (E′) for each category C. In step 540, an estimate is made of the regression coefficients for each category C. In one exemplary embodiment, the forecast and optimization computer 145 solves for the estimated regression coefficients using the generalized logistical regression equation (5):

$$log ( \frac{{E}^{′}}{1 - {E}^{′}} ) = {α}_{C} + {β}_{C} {a}_{C}^{′} + {γ}_{C} {L}_{C} + {η}_{C} {s}_{C} + {ɛ}_{C} for C ∈ OD . \qquad ( 5 )$$

The forecast and optimization computer 145 determines the proposed weighted average price (a) for category C using proposed prices (N) and historical share (h) for each product in category C in step 545. The proposed price (N) is typically accepted from the workstation 150. In one exemplary embodiment, the proposed price (N) represents a price different from the current price (p) and at which, the company would like to offer that product for sale. In step 550, the forecast and optimization computer 145 uses the regression coefficients estimated in step 540 to determine the estimated share of demand (E) for each category C 210-220 in the origin-destination pair 205. In one exemplary embodiment, a generalized logistical regression equation (6) in the following form is used to determining the estimated share of demand (E) for category C:

$$log ( \frac{E}{1 - E} ) = {α}_{C} + {β}_{C} {a}_{C} + {γ}_{C} {L}_{C} + {η}_{C} {s}_{C} + {ɛ}_{C} , \qquad ( 6 )$$

where α, β, γ, and η are coefficients, ε represents a random component that corresponds to the idiosyncrasies of the customer choice of category C, and C represents a category of products for the origin-destination pair 205. The process continues to step 315 of FIG. 3.

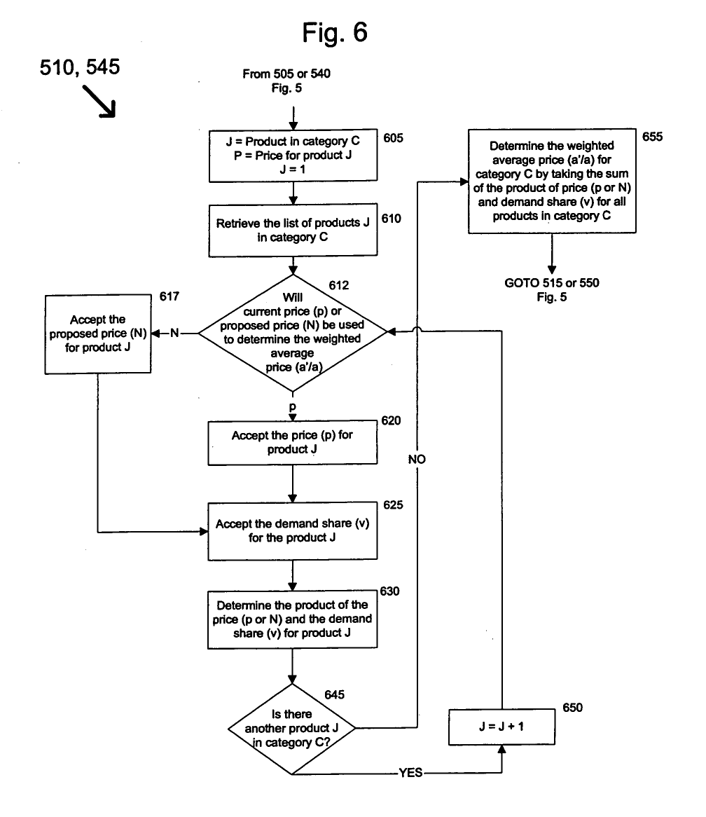

FIG. 6 is a logical flowchart diagram illustrating an exemplary computer-implemented process for determining the weighted average price (a′ or a) of category C as set out in steps 510 and 545 of FIG. 5. Now referencing FIGS. 1, 2, and 6, the process 510, 545 is initiated in step 605, where a counter variable J is set equal to one. The counter variable J typically represents one or more products in category C. In step 610, the forecast and optimization computer 145 retrieves the list of products J in category C from the revenue management system 105.

In step 612, an inquiry is conducted to determine if the current price (p) or proposed price (N) will be used for that product to determine the weighted average price (a′ or a) for category C. If the current price (p) will be used, the “p” branch is followed to step 620 where the forecast and optimization computer 145 retrieves the current price (p) for product J from the revenue management system 105. The process continues to step 625. Returning to step 612, if the proposed price (N) will be used, the “N” branch is followed to step 617, where the forecast and optimization computer 145 accepts the proposed price (N) for product J from the workstation 150. The process continues to step 625. In step 625, the forecast and optimization computer 145 accepts the demand share (v) for product J. The forecast and optimization computer 145 determines the product of the price (p or N) and the demand share (v) of product J in step 630.

In step 645, an inquiry is conducted to determine if there is another product J in category C. If so, the “YES” branch is followed to step 650, where the forecast and optimization computer 145 increases the counter variable J by one. Subsequently, the process returns to step 612. If category C does not contain another product J, the “NO” branch is followed to step 655, where the forecast and optimization computer takes the sum of the product of price (p or N) and demand share (v) for all products J in category C to determine the weighted average price (a′ or a) for category C. The process continues to step 515 or 550 of FIG. 5.

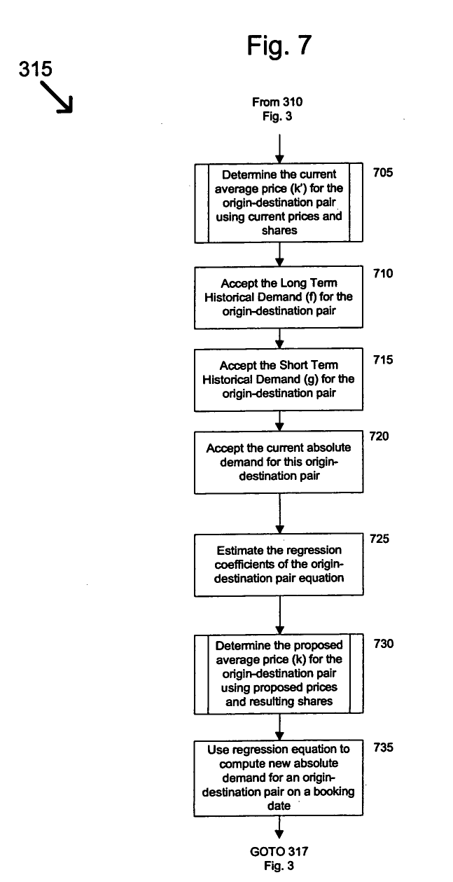

FIG. 7 is a logical flowchart diagram illustrating an exemplary computer-implemented process for determining the estimated absolute demand (D) for an origin-destination pair, as set forth in step 315 of FIG. 3. Referencing FIGS. 1, 2, and 7, the process 315 is initiated by the forecast and optimization computer 145 determining the current average price (k′) for the origin-destination pair using current price (p) and current demand share (E′) for categories in the origin-destination pair in step 705. The current price (p) can be retrieved from the revenue management system 105, while the current demand share (E′) for category C is determined in step 550 of FIG. 5.

In step 710, the forecast and optimization computer 145 accepts the long-term historical demand (f) for the origin-destination pair 205 from the historical sales data 110. The forecast and optimization computer 145 accepts the short-term historical demand (g) for the origin-destination pair 205 from the historical sales data 110 in step 715. In step 720, the forecast and optimization computer 145 accepts the current absolute demand (Q) for the origin-destination pair 205 from the historical sales data 110. An estimation of the regression coefficients for the simple regression equation is made through the workstation 150 in step 725. In one exemplary embodiment, the forecast and optimization computer 145 estimates the regression coefficients using the following regression equation (7):
Q=β₀+β₁k′+β₂f+β₃g+ε. (7)

In step 730, the forecast and optimization computer 145 determines the proposed average price (k) for the origin-destination pair using proposed price (N) and the estimated demand share (E) for each category C. The proposed price (N) can be accepted by the forecast and optimization computer 145 from the workstation 150. In step 735, the forecast and optimization computer uses a simple regression equation to determine the new estimated absolute demand (D) for an origin-destination pair on a booking date. In one exemplary embodiment, the regression equation (8) used by the forecast and optimization computer 145 is as follows:
D=β₀+β₁k+β₂f+β₃g+ε, (8)
wherein β₀, β₁, β₂, and β₃ represent coefficients in the simple regression equation and ε represents error. The process continues to step 317 of FIG. 3.

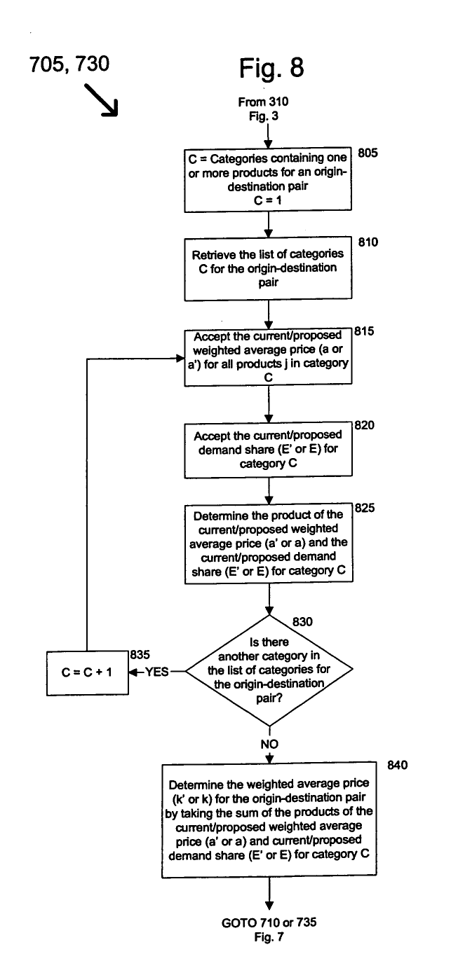

FIG. 8 is a logical flowchart diagram illustrating an exemplary computer-implemented process for completing the determination of an average price (k′ or k) for an origin-destination pair task of steps 705 and 730 of FIG. 7. Now referring to FIGS. 1, 2, and 8, the exemplary processes 705 and 730 is initiated in step 805, where a counter variable C is set equal to one. The counter variable C typically represents one or more categories 210-220 that can contain one or more products (J) 225-280 available for the origin-destination pair 205. In step 810, the forecast and optimization computer 145 retrieves the list of categories C 210-220 for the origin-destination pair 205 from the revenue management system 105.

In step 815, the forecast and optimization computer 145 accepts the current or proposed weighted average price (a′ or a) for all products (J) in category C from the revenue management system 105. In step 820, the forecast and optimization computer 145 accepts the current or estimated demand share (E′ or E) for category C as determined in step 550 of FIG. 5. The forecast and optimization computer 145 determines the product of the weighted average price (a′ or a) for all products in category C and the estimated demand share (E′ or E) for category C in step 825.

In step 830, an inquiry is conducted to determine if there is another category C in the list of categories for the origin-destination pair 205. If so, the “YES” branch is followed to step 835, where the forecast and optimization computer 145 increases the counter variable C by one. The process subsequently returns to step 815, where the forecast and optimization computer 145 accepts the weighted average price (a′ or a) for the next category C. If another category C does not exist for the origin-destination pair, then the “NO” branch is followed to step 840. In step 840, the forecast and optimization computer 145 determines the proposed weighted average price (k′ or k) for the origin-destination pair by taking the sum of the products of the weighted average price (a′ or a) and the estimated demand share (E′ or E) for each category C. The process continues to step 710 or 735 of FIG. 7.

No particular programming language has been described for carrying out the various procedures described above. It is considered that the operations, steps, and procedures described above and illustrated in the accompanying drawings are sufficiently disclosed to enable one of ordinary skill in the art to practice the present invention. However, there are many computers, operating systems, and application programs which may be used in practicing an exemplary embodiment of the present invention. Each user of a particular computer will be aware of the language and tools which are most useful for that user's needs and purposes. In addition, although the invention was described in the context of a consumer aviation industry application, those skilled in the art will appreciate that the invention can be extended to a wide variety of travel industries. It should be understood that the foregoing related only to specific embodiments of the present invention, and that numerous changes may be made therein without departing from the spirit and scope of the invention as defined by the following claims.

1. A computer-implemented method for determining an estimated demand for each product in an origin-destination pair comprising the steps of:
determining a product demand share for a product in a category of the origin-destination pair;
determining a category demand share for the category based on a proposed weighted average price for the category, a long-term demand share history for the category, and a short-term demand share history for the category; and
determining the estimated absolute demand for the origin-destination pair based on a proposed weighted average price for the origin-destination pair, a long-term demand history for the origin-destination pair and a short-term demand history for the origin-destination pair.

2. The method of claim 1, wherein determining the product demand share comprises the steps of:
a. accepting a list comprising at least one product in a first category;
b. accepting an actual price, a revenue management effect, a historical demand share, and a current demand share for a first product in the first category;
c. repeating step (a)-(b) for all products in the first category
d. determining a set of estimated regression coefficients based on the actual price, the revenue management effect, the historical demand share, and the current demand share for all products in the first category;
e. accepting a proposed price for at least one product in the first category; and
f. determining the demand share for all of the products in the first category based on the proposed price, the revenue management effect, the historical demand share, and the estimated regression coefficients.

3. The method of claim 2 further comprising the step of determining the product demand share for at least one product in a second category in the origin-destination pair.

4. The method of claim 2, wherein the estimated regression coefficients and the demand share for all products in the first category is determined by solving a multinomial logistical regression model.

5. The method of claim 2, wherein the estimated regression coefficients and the demand share for all products in the first category is determined by solving a nested logistical regression model.

6. The method of claim 2, wherein the estimated regression coefficients and the demand share for all products in the first category is determined by solving a regression model.

7. The method of claim 1, wherein the step of determining the product demand share comprises the steps of:
a. accepting a list comprising at least one product in a first category;
b. accepting an actual price, a revenue management effect, a historical demand share, and a current demand share for a first product in the first category;
c. accepting a competitor's price and a competitor's revenue management effect for a competitor product substantially equivalent to the first product;
d. repeating step (a)-(c) for all products in the first category;
e. determining a set of estimated regression coefficients based on the actual price, the revenue management effect, the historical demand share, and the current demand share for all products in the first category and the competitor's price and the competitor's revenue management effect for each competitor product substantially equivalent to at least one product in the first category;
f. accepting a proposed price for at least one product in the first category; and
g. determining the demand share for all of the products in the first category based on the proposed price, the revenue management effect, the historical demand share, and the estimated regression coefficients for each product in the first category and the competitor's price and the competitor's revenue management effect for each competitor product substantially equivalent to at least one product in the first category.

8. The method of claim 7, wherein the estimated regression coefficients and the demand share for all products in the first category is determined by solving a multinomial logistical regression model.

9. The method of claim 7, wherein the estimated regression coefficients and the demand share for all products in the first category is determined by solving a nested logistical regression model.

10. The method of claim 7, wherein the estimated regression coefficients and the demand share for all products in the first category is determined by solving a regression model.

11. The method of claim 1, wherein the step of determining the product demand share comprises the steps of:
a. accepting a list comprising at least one product in a first category;
b. accepting an actual price, a revenue management effect, a historical demand share, and a current demand share for a first product in the first category;
c. accepting a competitor's price and a competitor's revenue management effect for a competitor product substantially equivalent to the first product;
d. repeating step (a)-(c) for all products in the first category;
e. determining a set of estimated regression coefficients based on the actual price, the revenue management effect, the historical demand share, and the current demand share for all products in the first category and the competitor's price and the competitor's revenue management effect for each competitor product substantially equivalent to at least one product in the first category;
f. accepting a competitor's new price for at least one competitor product that is substantially equivalent to at least one product in the first category; and
g. determining the demand share for all of the products in the first category based on the actual price, the revenue management effect, the historical demand share, and the estimated regression coefficients for each product in the first category and the competitor's new price and the competitor's revenue management effect for each competitor product substantially equivalent to at least one product in the first category.

12. The method of claim 11, wherein the estimated regression coefficients and the demand share for all products in the first category is determined by solving a multinomial logistical regression model.

13. The method of claim 11, wherein the estimated regression coefficients and the demand share for all products in the first category is determined by solving a nested logistical regression model.

14. The method of claim 11, wherein the estimated regression coefficients and the demand share for all products in the first category is determined by solving a regression model.

15. The method of claim 1, wherein the step of determining the product demand share comprises the steps of:
a. accepting a list comprising at least one product in a first category;
b. accepting an actual price, a revenue management effect, a historical demand share, and a current demand share for a first product in the first category;
c. accepting a competitor's price and a competitor's revenue management effect for a competitor product substantially equivalent to the first product;
d. repeating step (a)-(c) for all products in the first category
e. determining a set of estimated regression coefficients based on the actual price, the revenue management effect, the historical demand share, and the current demand share for all products in the first category and the competitor's price and the competitor's revenue management effect for each competitor product substantially equivalent to at least one product in the first category;
f. accepting a competitor's new revenue management effect for at least one competitor product that is substantially equivalent to at least one product in the first category; and
g. determining the demand share for all of the products in the first category based on the actual price, the revenue management effect, the historical demand share, and the estimated regression coefficients for each product in the first category and the competitor's price and the competitor's new revenue management effect for each competitor product substantially equivalent to at least one product in the first category.

16. The method of claim 15, wherein the estimated regression coefficients and the demand share for all products in the first category is determined by solving a multinomial logistical regression model.

17. The method of claim 15, wherein the estimated regression coefficients and the demand share for all products in the first category is determined by solving a nested logistical regression model.

18. The method of claim 15, wherein the estimated regression coefficients and the demand share for all products in the first category is determined by solving a regression model.

19. The method of claim 1, wherein determining the category demand share for a first category of the origin-destination pair further comprises the steps of:
a. determining the current weighted average price for the first category based on a current price and a current demand share for each product in the first category;
b. accepting the long-term demand share history and the short-term demand share history for the first category;
c. repeating steps (a)-(b) for each category in the origin-destination pair;
d. accepting the current demand share for each category in the origin-destination pair;
e. determining a set of estimated regression coefficients for each category based on the weighted average price, the long-term demand share history, and the short-term demand share history for each category in the origin-destination pair;
f. determining the proposed weighted average price for each category based on a proposed price and a proposed demand share for each product in each category of the origin-destination pair; and
g. determining the demand share for each category of the origin-destination pair based on the proposed weighted average price, the long-term demand share history, and the short-term demand share history for each category.

20. The method of claim 19, wherein the demand share for each category in the origin-destination pair is determined using a regression model.

21. The method of claim 19, wherein determining the weighted average price for the first category further comprises the steps of:
a. accepting an actual price and a current demand share for a first product in the first category of the origin-destination pair;
b. determining a multiplied product of the actual price and the current demand share for the first product;
c. repeating steps (a)-(b) for each product in the first category; and
d. determining the weighted average price for the first category by generating a sum of the multiplied products determined in step (b) and (c).

22. The method of claim 19, wherein determining the proposed weighted average price for the first category further comprises the steps of:
a. accepting a proposed price and the product demand share for a first product in the first category of the origin-destination pair;
b. determining a multiplied product of the proposed price and the product demand share for the first product;
c. repeating steps (a)-(b) for each product in the first category; and
d. determining the proposed weighted average price for the first category by generating a sum of the multiplied products determined in step (b) and (c).

23. The method of claim 1, wherein determining the estimated absolute demand for the origin-destination pair further comprises the steps of:
determining a current average price for the origin-destination pair based on at least one current weighted average price and at least one current demand share for all products in each category of the origin-destination pair;
accepting the long-term demand history, short-term demand history, and a current absolute demand for the origin-destination pair;
determining a set of estimated regression coefficients based on the current average price, long-term demand history, short-term demand history, and the current absolute demand for the origin-destination pair;
determining a proposed average price for the origin-destination pair based on the category demand share for each category in the origin-destination pair and at least one proposed price for at least one product in at least one category of the origin-destination pair; and
determining the absolute demand for an origin-destination pair, based on the proposed average price for the origin-destination pair and the long-term and short-term demand history for the origin-destination pair.

24. The method of claim 23, wherein the absolute demand for the origin-destination pair is determined using a simple regression model.

25. The method of claim 23, wherein the absolute demand for the origin-destination pair is a booking day absolute demand for the origin-destination pair.

26. The method of claim 23, wherein determining the current average price for the origin-destination pair further comprises:
a. accepting the current weighted average price for a first category;
b. accepting a current demand share for the first category;
c. determining a multiplied product of the current weighted average price for the first category and the current demand share for the first category;
d. repeating steps (a)-(c) for each category of the origin-destination pair; and
e. determining the proposed weighted average price for the origin-destination pair by taking a sum of the multiplied products determined for each category of the origin-destination pair.

27. The method of claim 1 further comprising the step of generating a category forecast based on the absolute demand for the origin-destination pair and the category demand share.

28. The method of claim 27, wherein generating the category forecast comprises the step of taking the product of the category demand share for the category and the estimated absolute demand for the origin-destination pair.

29. The method of claim 1 further comprising the step of generating a product demand forecast based on the category forecast and the product demand share.

30. The method of claim 29 wherein generating the product demand forecast comprises the step of taking the product of the category forecast and the product demand share.

31. A computer-readable medium having computer-executable instructions for performing the steps recited in claim 1.

32. A computer-implemented method for determining an estimated absolute demand (D) for an origin-destination pair (OD) comprising the steps of:
determining a product demand share (v) for a product (j) in a category (C) of the origin-destination pair;
determining a category demand share (E) for the category (C) based on a proposed weighted average price (a) for the category, a long-term demand share history (L) for the category, and a short-term demand share history (s) for the category using the formula
E=α_{C}+β_{C}a_{C}+γ_{C}L_{C}+η_{C}s_{C}+ε_{C} CεOD; and
determining the estimated absolute demand (D) for the origin-destination pair based on a proposed weighted average price for the origin-destination pair (k), a long-term demand history (f) for the origin-destination pair and a short-term demand history (g) for the origin-destination pair using the formula
D=β₀+β₁k+β₂f+β₃g+ε.

33. The method of claim 32, wherein determining the product demand share (v) comprises the steps of:
a. accepting a list comprising at least one product (j) in a first category (C);
b. accepting an actual price (p), a revenue management effect (r), a historical demand share (h), and a current demand share (h′) for a first product in the first category;
c. repeating step (a)-(b) for all products in the first category
d. determining a set of estimated regression coefficients based on the actual price (p), the revenue management effect (r), the historical demand share (h), and the current demand share (h′) for all products in the first category using the formula
h′ⱼ=αⱼ+βⱼpⱼ+γⱼrⱼ+ηⱼhⱼ for jεC;
e. accepting a proposed price (N) for at least one product in the first category; and
f. determining the demand share (v) for all of the products in the first category based on the proposed price (N), the revenue management effect (r), the historical demand share (h), and the estimated regression coefficients using the formula
vⱼ=αⱼ+βⱼNⱼ+γⱼrⱼ+ηⱼhⱼ for jεC

34. The method of claim 33 further comprising the step of determining the product demand share (v) for at least one product (j) in a second category (C) in the origin-destination pair.

35. The method of claim 32, wherein the step of determining the product demand share (v) comprises the steps of:
a. accepting a list comprising at least one product (j) in a first category (C);
b. accepting an actual price (p), a revenue management effect (r), a historical demand share (h), and a current demand share (h′) for a first product in the first category;
c. accepting a competitor's price (b) and a competitor's revenue management effect (d) for a competitor product substantially equivalent to the first product;
d. repeating step (a)-(c) for all products in the first category
e. determining a set of estimated regression coefficients based on the actual price (p), the revenue management effect (r), the historical demand share (h), and the current demand share (h′) for all products in the first category and the competitor's price (b) and the competitor's revenue management effect (d) for each competitor product substantially equivalent to at least one product in the first category using the formula
h′ⱼ=αⱼ+βⱼpⱼ+γⱼrⱼ+ηⱼhⱼ+λⱼbⱼ+ωⱼdⱼ for jεC;
f. accepting a proposed price (N) for at least one product in the first category; and
g. determining the demand share (v) for all of the products in the first category based on the proposed price (N), the revenue management effect (r), the historical demand share (h), and the estimated regression coefficients for each product in the first category and the competitor's price (b) and the competitor's revenue management effect (d) for each competitor product substantially equivalent to at least one product in the first category using the formula
vⱼ=αⱼ+βⱼNⱼ+γⱼrⱼ+ηⱼhⱼ+λⱼbⱼ+ωⱼdⱼ for jε C.

36. The method of claim 32, wherein the step of determining the product demand share (v) comprises the steps of:
a. accepting a list comprising at least one product (j) in a first category (C);
b. accepting an actual price (p), a revenue management effect (r), a historical demand share (h), and a current demand share (h′) for a first product in the first category;
c. accepting a competitor's price (b) and a competitor's revenue management effect (d) for a competitor product substantially equivalent to the first product;
d. repeating step (a)-(c) for all products (j) in the first category (C)
e. determining a set of estimated regression coefficients using the formula
h′ⱼ=αⱼ+βⱼpⱼ+γⱼrⱼ+ηⱼhⱼ+λⱼbⱼ+ωⱼdⱼ for jεC;
f. accepting a competitor's new price (b′) for at least one competitor product that is substantially equivalent to at least one product in the first category; and
g. determining the demand share (v) for all of the products in the first category using the formula
vⱼ=αⱼ+βⱼp_{j+γ}ⱼrⱼ+ηⱼhⱼ+λⱼb′ⱼ+ωⱼdⱼ for jεC.

37. The method of claim 32, wherein the step of determining the product demand share (v) comprises the steps of:
a. accepting a list comprising at least one product ( ) in a first category (C);
b. accepting an actual price (p), a revenue management effect (r), a historical demand share (h), and a current demand share (h′) for a first product in the first category;
c. accepting a competitor's price (b) and a competitor's revenue management effect (d) for a competitor product substantially equivalent to the first product;
d. repeating step (a)-(c) for all products in the first category;
e. determining a set of estimated regression coefficients using the formula
h′ⱼ=αⱼ+βⱼpⱼ+γⱼrⱼ+ηⱼhⱼ+λⱼbⱼ+ωⱼdⱼ for jεC;
f. accepting a competitor's new revenue management effect (d′) for at least one competitor product that is substantially equivalent to at least one product in the first category; and
g. determining the demand share (v) for all of the products in the first category using the formula
vⱼ=αⱼ+βⱼpⱼ+γⱼrⱼ+ηⱼhⱼ+λⱼb′ⱼ+ωⱼd′ⱼ for jεC.

38. The method of claim 32, wherein determining the category demand share (E) for a first category (C) of the origin-destination pair further comprises the steps of:
a. determining the current weighted average price (a′) for the first category based on a current price (p) and a current demand share (h′) for each product in the first category;
b. accepting the long-term demand share history (L) and the short-term demand share history (s) for the first category;
c. repeating steps (a)-(b) for each category in the origin-destination pair;
d. accepting the current demand share (E′) for each category in the origin-destination pair;
e. determining a set of estimated regression coefficients for each category using the formula
E′=α_{C}+β_{C}a′_{C}+γ_{C}L_{C}+η_{C}s_{C}+ε_{C} for CεOD;
f determining the proposed weighted average price (a) for each category based on at least one proposed price (N) and a current demand share (E′) for each product in each category of the origin-destination pair; and
g. determining the demand share (E) for each category of the origin-destination using the formula
E=α_{C}+β_{C}a_{C}+γ_{C}L_{C}+η_{C}s_{C}+ε_{C} for CεOD.

39. The method of claim 38, wherein determining the current weighted average price (a′) for the first category (C) further comprises the steps of:
a. accepting the current price (p) and the current demand share (h) for a first product (j) in the first category of the origin-destination pair;
b. determining the current weighted average price (a′) using the formula
a′=pⱼhⱼ for jεC; and
c. repeating steps (a)-(b) for each product in the first category.

40. The method of claim 38, wherein determining the proposed weighted average price (a) for the first category (C) further comprises the steps of:
a. accepting a proposed price (N) and the product demand share (v) for a first product in the first category of the origin-destination pair;
b. determining the proposed weighted average price (a) for the first category (C) using the formula
a=Nⱼvⱼ for jεC; and
c. repeating steps (a)-(b) for each product (j) in the first category (C).

41. The method of claim 32, wherein determining the estimated absolute demand (D) for the origin-destination pair comprises the steps of:
determining a current average price (k′) for the origin-destination pair based on at least one current weighted average price (a′) and at least one current demand share (E′) for all products in each category of the origin-destination pair;
accepting the long-term demand history (f), short-term demand history (g), and a current absolute demand (Q) for the origin-destination pair;
determining a set of estimated regression coefficients using the formula
Q=β₀+β₁k′+β₂f+β₃g+ε;
determining a proposed average price (k) for the origin-destination pair based on the category demand share (E) for each category in the origin-destination pair and at least one proposed price (N) for at least one product (j) in at least one category of the origin-destination pair; and
determining the absolute demand (D) for an origin-destination pair using the formula
D=β₀+β₁k+β₂f+β₃g+ε.

42. The method of claim 41, wherein the absolute demand (D) for the origin-destination pair is a booking day absolute demand for the origin-destination pair.

43. The method of claim 41, wherein determining the current average price (k′) for the origin-destination pair (OD) further comprises:
a. accepting the current weighted average price (a′) for a first category (C);
b. accepting a current demand share (E′) for the first category;
c. determining a product of the current weighted average price for the first category and the current demand share for the first category using the formula
z=E′_{C}a′_{C}; for CεOD;
d. repeating steps (a)-(c) for each category of the origin-destination pair; and
e. determining the proposed weighted average price for the origin-destination pair using the formula
k=ΣE′_{C}a′_{C}; for CεOD.

44. The method of claim 41, wherein determining the proposed average price (k) for the origin-destination pair (OD) further comprises:
a. accepting the proposed weighted average price (a′) for a first category (C);
b. accepting the category demand share (E) for the first category;
c. determining proposed average price (k) using the formula
k=E_{C}a_{C}; for CεOD; and
d. repeating steps (a)-(c) for each category of the origin-destination pair.

45. The method of claim 32 further comprising the step of generating a category forecast (CF) using the formula
CF=(D)×(E).

46. The method of claim 45 further comprising the step of generating a product demand forecast based on the absolute demand for the origin-destination pair and the category forecast.

47. The method of claim 46, wherein generating a product demand (PD) forecast comprises the formula
PD=(vⱼ)×(CF).

48. A computer-readable medium having computer-executable instructions for performing the steps recited in claim 32.

49. A system for estimating price elasticity of origin-destination product demand comprising:
a first information database for storing current inventory information describing products currently available to a consumer, wherein the inventory information includes long-term demand share history for an origin-destination pair, short-term demand share history for the origin-destination pair, long-term demand share history for a category of products in the origin-destination pair, short-term demand share history for the category of products in the origin-destination pair, historical demand share history for products in the origin-destination pair, a set of products for the origin-destination pair, a set of categories including one or more of the products for the origin-destination pair, and a revenue management effect for each product in the origin-destination pair;
a second information database for storing current and historical pricing patterns for the current inventory and a competitor's current inventory;
a third information database for storing current information related to competitor products, wherein the information is retrieved from publicly available sources and the information is used to estimate the revenue management effect for a competitor's product;
a competitive product evaluator coupled to the second information database for comparing the current inventory information to the competitor's current inventory to determine at least one competitor product that is substantially equivalent to a product in the current inventory; and
a demand forecasting determiner coupled to the first information database, the third information database, and the competitive product evaluator for estimating a demand for a product in the category of the origin-destination pair.

50. The system of claim 49, wherein the first information database comprises a commercial airline reservation system.

51. The system of claim 49, wherein the second information database comprises a commercial product price publishing system.

52. The system of claim 49, wherein the demand forecasting determiner is further coupled to a user input workstation, wherein the workstation allows for the insertion of proposed prices for the current inventory.
